(19) United States
(12) Patent Application Publication
(10) Pub. No.: US 2026/0187678 A1
(43) Pub. Date: Jul. 2, 2026

(54) SYSTEMS AND METHODS FOR GENERATING A CORRELATION SCORE THAT IS DYNAMICALLY UPDATED AND WEIGHTED BASED UPON PARAMETER SELECTION

(71) Applicant: Worldpay, LLC, Symmes Township, OH (US)

(72) Inventor: James Franklin HEWITT, JR., Cincinnati, OH (US)

(21) Appl. No.: 17/657,172

(22) Filed: Mar. 30, 2022

Related U.S. Application Data
(63) Continuation of application No. 14/521,806, filed on Oct. 23, 2014, now abandoned.

(51) Int. Cl. G06Q 30/0251; G06Q 20/40

(52) U.S. Cl. CPC G06Q 30/0269; G06Q 20/4014; G06Q 30/0256

(57) ABSTRACT

Systems and methods are provided for generating a consumer profile report from transaction data obtained from a payment ecosystem. A consumer is provided with an opportunity to select the transaction data available for generation of the consumer profile report.

### TECHNICAL FIELD

The systems and methods described below relate generally to the field of consumer profiling. More particularly, the systems and methods relate to the field of generating a consumer profile report based upon transaction data obtained from a payment ecosystem.

### BACKGROUND

Merchants use targeted marketing initiatives to try and reach consumer bases that are likely to be impacted by the merchant's marketing efforts. The effectiveness of these targeted marketing campaigns can depend upon the overall integrity of the consumer data upon which the campaign is based. Consumer data is oftentimes gathered from a consumer without the consumer having an opportunity to review and manage their consumer data. As a result, the merchant's targeted marketing initiative might not be particularly effective.

### SUMMARY OF THE DISCLOSURE

In an embodiment, the present disclosure is directed, in part, to a computer-implemented method. The computer-implement method comprises receiving, by a profiling computing system from an issuer financial institution, first financial data of a financial account of a consumer, wherein the financial account is maintained by the issuer financial institution. The method further comprises receiving, by a profiling computing system from a demand deposit account provider, second financial data of a demand deposit account of the consumer, wherein the demand deposit account is maintained by the demand deposit account provider. The method further comprises storing the first transaction data and the second transaction data in a transaction data database and receiving, by the profiling computing system from the consumer, selected transaction data for inclusion in a consumer profile report, wherein the selected transaction data comprises at least one of the first transaction data and the second transaction data. The method still further provides receiving, by the profiling computing system from a subscribing entity, a selection of parameters for a consumer profile report and generating, by the profiling computing system, the consumer profile report based upon the selected transaction data and the selection of parameters.

In one embodiment, the present disclosure is directed, in part, to a non-transitory computer readable medium. The computer readable medium has instructions stored thereon which when executed by a processor cause the processor to receive, by a profiling computing system from an issuer financial institution, first financial data of a financial account of a consumer, wherein the financial account is maintained by the issuer financial institution. The instructions further cause the processor to receive, by a profiling computing system from a demand deposit account provider, second financial data of a demand deposit account of the consumer, wherein the demand deposit account is maintained by the demand deposit account provider. The instructions further cause the processor to store the first transaction data and the second transaction data in a transaction data database and receive, by the profiling computing system from the consumer, selected transaction data for inclusion in a consumer profile report, wherein the selected transaction data comprises at least one of the first transaction data and the second transaction data. The instructions further cause the processor to receive, by the profiling computing system from a subscribing entity, a selection of parameters for a consumer profile report and generate, by the profiling computing system, the consumer profile report based upon the selected transaction data and the selection of parameters. An authenticity of the consumer profile report is certified.

In one embodiment, the present disclosure is directed, in part, to a system. The system comprises means for receiving from an issuer financial institution, first financial data of a financial account of a consumer, wherein the financial account is maintained by the issuer financial institution. The system further comprises means for receiving from a demand deposit account provider, second financial data of a demand deposit account of the consumer, wherein the demand deposit account is maintained by the demand deposit account provider. The system further comprises means for storing the first transaction data and the second transaction data in a transaction data database and means for receiving, by the profiling computing system from the consumer, selected transaction data for inclusion in a consumer profile report, wherein the selected transaction data comprises at least one of the first transaction data and the second transaction data. The system still further comprises means for receiving, by the profiling computing system from a subscribing entity, a selection of parameters for a consumer profile report and means for generating, by the profiling computing system, the consumer profile report based upon the selected transaction data and the selection of parameters. The system still further comprises means for generating a consumer profile report authentication certificate based upon the selected transaction data.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts a system according to one embodiment which includes a consumer profiling computer system for facilitating generation of a consumer profile report from a consumer's transaction data.

FIG. 2 schematically depicts one example of a graphical user interface of a computing device associated with the consumer profiling computer system.

FIG. 3 schematically depicts another example of a graphical user interface of a computing device associated with the consumer profiling computer system

### DETAILED DESCRIPTION OF EMBODIMENTS

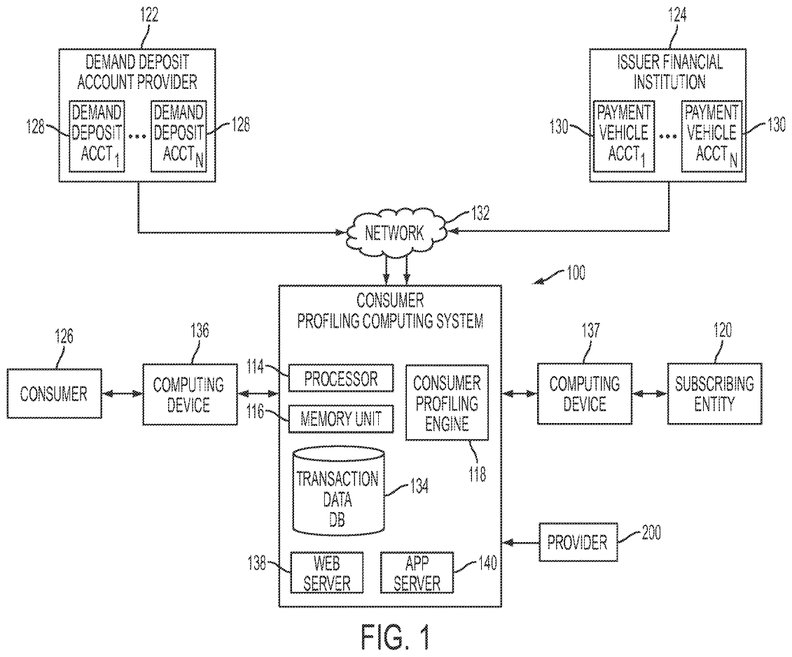

Various non-limiting embodiments of the present disclosure will now be described to provide an overall understanding of the principles of the structure, function, and use of systems and methods disclosed herein for generating a consumer profile based upon transaction data obtained from a payment ecosystem. One or more examples of these non-limiting embodiments are illustrated in the selected examples disclosed and described in detail with reference made to FIGS. 1-3 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

For simplicity, the description that follows will be provided by reference to a “payment vehicle,” which generally refers to any type of financial alternative to currency. As is to be clear to those skilled in the art, no aspect of the present disclosure is specifically limited to a specific type of payment vehicle. Therefore, it is intended that the following description encompasses the use of the present disclosure with many other forms of financial alternatives to currency, including credit cards, debit cards, smart cards, single-use cards, pre-paid cards, electronic currency (such as might be provided through a cellular telephone or personal digital assistant), and the like. Payment vehicles can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A payment vehicle can also have electronic functionality provided by a network of electronic circuitry that is printed or otherwise incorporated onto or within the payment vehicle (and typically referred to as a “smart card”), or be a fob having a transponder and an RFID reader.

Referring now to FIG. 1, one example embodiment of the present disclosure can comprise a computer-based consumer profiling computing system 100. The consumer profiling computing system 100 can be provided using any suitable processor-based device or system, such as a personal computer, laptop, server, mainframe, or a collection (e.g., network) of multiple computers, for example. The consumer profiling computing system 100 can include one or more processors 114 and one or more computer memory units 116. For convenience, only one processor 114 and only one memory unit 116 are shown in FIG. 1. The processor 114 can execute software instructions stored on the memory unit 116. The processor 114 can be implemented as an integrated circuit (IC) having one or multiple cores. The memory unit 116 can include volatile and/or non-volatile memory units. Volatile memory units can include random access memory (RAM), for example. Non-volatile memory units can include read only memory (ROM), for example, as well as mechanical non-volatile memory systems, such as, for example, a hard disk drive, an optical disk drive, etc. The RAM and/or ROM memory units can be implemented as discrete memory ICs, for example.

The memory unit 116 can store executable software and data for a consumer profiling engine 118. When the processor 114 of the consumer profiling computing system 100 executes the software of the consumer profiling engine 118, the processor 114 can be caused to perform the various operations of the consumer profiling computing system 100, such as receive transaction data, certify or otherwise authenticate the transaction data, generate a consumer profile report based upon the transaction data, and transmit the consumer profile report to a subscribing entity 120, as discussed in more detail below. It is to be appreciated that a subscribing entity can be understood to mean a merchant, a seller, a manufacturer, a marketer, an agency, a loyalty rewards provider or any of a variety of other entities that receive consumer profile report in accordance with the present disclosure.

The transaction data used by the consumer profiling engine 118 can be received from various participating members, such as a demand deposit account provider 122 and a payment vehicle issuer financial institution 124, for example. A consumer 126 can have one or more demand deposit accounts 128 maintained by the demand deposit account provider 122 and can have one or more payment vehicle accounts 130 maintained by the issuer financial institution 124. The demand deposit account 128 can be any type of suitable demand deposit account such as a checking account, an investment account, a savings account, or a money market account, for example. The payment vehicle account 130 can be any type of suitable payment vehicle account such as a credit account, a stored value account, or a mobile payment account, for example. The consumer's accounts 130 can be linked to a payment vehicle (not shown). Depending on the type of demand deposit account 128, it can also be linked to a payment vehicle (not shown). In some embodiments, each account can have its own dedicated payment vehicle while in other embodiments a payment vehicle can be linked to multiple accounts. The payment vehicle(s) can be used to pay a merchant for a payment vehicle transaction.

When a purchase transaction is initiated with a merchant using a payment vehicle, transaction data for the purchase transaction can be provided to the demand deposit account provider 122 and/or the payment vehicle issuer financial institution 124 over a payment network (not shown) for settlement (e.g., approval or denial). The payment network can be, for example, a network of a credit card associations affiliated with the payment vehicle. Non-limiting examples of credit card associations include VISA, MASTERCARD, DISCOVER, and AMERICAN EXPRESS. If the purchase transaction is approved, the transaction data can be used to post the purchase transaction to the consumer's account linked to the payment vehicle for later reconciliation.

A consumer can also initiate various types of transactions associated with the demand deposit account 128. Such transactions can include, for example, withdraws and deposits. If the demand deposit account 128 is liked to a payment vehicle, transactions using that linked payment vehicle can be posted to the demand deposit account 128.

The demand deposit account provider 122 and the payment vehicle issuer financial institution 124 can be in communication with the consumer profiling computing system 100 over a network 132. The transaction data received by the demand deposit account provider 122 and the payment vehicle issuer financial institution 124 can be provided to the consumer profiling computing system 100 over the network 132. In some embodiments, the transaction data can be provided to the consumer profiling computing system 100 periodically, such as, for example, weekly, daily, hourly, or immediately upon settlement of each transaction. In other embodiments, the transaction data can additionally or alternatively be provided in response to a request from the consumer profiling computing system 100. In some embodiments, the network 132 might not be associated with the payment network (described above) but instead can be a dedicated network for communicating directly with the consumer profiling computing system 100, such as, for example, a Secure/PC! Compliant network connection.

It will be appreciated that the transaction data provided to the consumer profiling computing system 100 can be transaction data for a plurality of account holders at the demand deposit account provider 122 and the payment vehicle issuer financial institution 124. In one embodiment, the demand deposit account provider 122 and the payment vehicle issuer financial institution 124 can release the transaction data to the consumer profiling computing system 100 only after receiving prior authorization from the particular account holder(s) to whom the transaction data is associated.

The transaction data received by the profiling computing system from the demand deposit account provider 122 and the payment vehicle issuer financial institution 124 can be stored in a transaction data database 134. The transaction data stored in the transaction data database 134 can be stored in a non-volatile computer memory, such as a hard disk drive, a read only memory (e.g., a ROM IC), or other types of non-volatile memory. In some embodiments, the transaction data database 134 can be stored on a remote electronic computer system, for example. As it is to be appreciated, a variety of other databases, or other types of memory storage structures, can be utilized or otherwise associated with the consumer profiling computing system 100.

The consumer profiling computing system 100 can be in communication with a consumer computing device, referred to generally as 136 and a subscribing entity computing device 137, via an electronic communications network. The communications network can include a number of computer and/or data networks, including the Internet, LANs, WANs, GPRS networks, etc., and can comprise wired and/or wireless communication links. As described in more detail below, the computing devices 136, 137 can interact with the consumer profiling computing system 100 through a web or application-based user interface presented to the consumer 126 through the computing devices 136, 137.

The computing devices 136, 137 can be any type computer device suitable for communication over the network, such as a wearable computing device, a mobile telephone, a tablet computer, a device that is a combination handheld computer and mobile telephone (sometimes referred to as a “smart phone”), a personal computer (such as a laptop computer, netbook computer, desktop computer, and so forth), or any other suitable computing device, such as personal digital assistants (PDA), mobile gaming devices, or media players, for example. Examples of wearable computing device (sometimes referred to as a “wearable”) includes devices that incorporate an augmented reality head-mounted display as well as other computing devices that can be worn on or within the body of the user.

In some example embodiments, the computing devices 136, 137 can be arranged to perform data communications functionality in accordance with shorter range wireless networks, such as a wireless personal area network (PAN) offering Bluetooth® data communications services in accordance with the Bluetooth®. Special Interest Group (SIG) series of protocols, specifications, profiles, and so forth. Other examples of shorter range wireless networks can employ infrared (IR) techniques or near-field communication techniques and protocols, such as electromagnetic induction (EMI) techniques including passive or active radio-frequency identification (RFID) protocols and devices. The computing devices 136, 137 can comprise one or more internal and/or external antennas to support operation in multiple frequency bands or sub-bands such as the 2.4 GHz range of the ISM frequency band for Wi-Fi and Bluetooth® communications, one or more of the 850 MHz, 900 MHz, 1800 MHz, and 1900 MHz frequency bands for GSM, CDMA, TDMA, NAMPS, cellular, and/or PCS communications, the 2100 MHz frequency band for CDMA2000/EV-DO and/or WCDMA/JMTS communications, the 1575 MHz frequency band for Global Positioning System (GPS) operations, and others.

The computing devices 136, 137 can, in some embodiments, provide a variety of applications for allowing the consumer 126 and the subscribing entity 120, respectively to accomplish one or more specific tasks using the consumer profiling computing system 100. Applications can include, without limitation, a web browser application (e.g., INTERNET EXPLORER, MOZILLA, FIREFOX, SAFARI, OPERA, NETSCAPE NAVIGATOR) telephone application (e.g., cellular, VoIP, PTT), networking application, messaging application (e.g., e-mail, IM, SMS, MMS, BLACKBERRY Messenger), and so forth. The computing devices 136, 137 can comprise various software programs such as system programs and applications to provide computing capabilities in accordance with the described embodiments. System programs can include, without limitation, an operating system (OS), device drivers, programming tools, utility programs, software libraries, application programming interfaces (APIs), and so forth. Exemplary operating systems can include, for example, a PALM OS, MICROSOFT OS, APPLE OS, ANDORID OS, UNIX OS, LINUX OS, SYMBIAN OS, EMBEDIX OS, Binary Run-time Environment for Wireless (BREW) OS, JavaOS, a Wireless Application Protocol (WAP) OS, and others.

The computing devices 136, 137 can include various components for interacting with the consumer profiling computing system 100, such as a display for presenting the virtual content, a camera for receiving optical input, and a keypad for inputting data and/or commands. The computing devices 136, 137 can include other components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, and so forth.

The consumer 126 and the subscribing entity 120 can interact with the consumer profiling computing system 100 via a variety of other electronic communications techniques, such as, without limitation, HTTP requests. The electronic communications can be generated by a specialized application executed on the computing devices 136, 137 or can be generated using one or more applications that are generally standard to the computing devices 136, 137. The applications can include or be implemented as executable computer program instructions stored on computer-readable storage media such as volatile or non-volatile memory capable of being retrieved and executed by a processor to provide operations for the computing devices 136, 137. The memory can also store various databases and/or other types of data structures (e.g., arrays, files, tables, records) for storing data for use by the processor and/or other elements of computing devices 136, 137.

As shown in FIG. 1, the consumer profiling computing system 100 can include several computer servers and databases. For example, the consumer profiling computing system 100 can include one or more web servers 138, application servers 140, and/or any other type of servers. For convenience, only one web server 138 and one application server 140 are shown in FIG. 1, although it should be recognized that the disclosure is not so limited. The servers can cause content to be sent to the to the computing devices 136, 137 in any number of formats, such as text-based messages, multimedia message, email messages, smart phone notifications, web pages, and so forth. The servers 138, 140 can comprise processors (e.g., CPUs), memory units (e.g., RAM, ROM), non-volatile storage systems (e.g., hard disk drive systems), etc. The servers 138, 140 can utilize operating systems, such as Solaris, Linux, or Windows Server operating systems, for example.

The web server 138 can provide a graphical web user interface through which various users of the system can interact with the consumer profiling computing system 100. The web server 138 can accept requests, such as HTTP requests, from clients (such as respective web browsers on the computing devices 136, 137), and serve the clients responses, such as HTTP responses, along with optional data content, such as web pages (e.g., HTML documents) and linked objects (such as images, video, and so forth).

The application server 140 can provide a user interface for users who do not communicate with the consumer profiling computing system 100 using a web browser. Such users can have special software installed on their computing devices 136, 137 that allows them to communicate with the application server 140 via the network. Such software can be downloaded, for example, from the consumer profiling computing system 100, or other software application provider, over the network to computing devices 136, 137.

Although FIG. 1 depicts a limited number of elements for purposes of illustration, it can be appreciated that the consumer profiling computing system 100 can include more or less elements as well as other types of elements in accordance with the described embodiments. Elements of the consumer profiling computing system 100 can include physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

Once the consumer's transaction data is stored in the transaction data database 134, a consumer profile report can be generated from the transaction data and provided to the subscribing entity 120. As described in more detail below, the consumer profile report can be certified such that the authentication of the information provided within the report is verified. In some embodiments, the consumer profile report is used to aid in implementing certain consumer marketing initiatives, such as targeted marketing and loyalty rewards programs, for example, or perform other types of consumer research.

Since the consumer profile report can be comprised of the consumer's transaction data, the consumer 126 can be given the opportunity to select whether, and to what extent, certain transaction data is available for inclusion in the consumer profile report. The consumer can select the transaction data available for the consumer profile report. By providing the consumer 126 the ability to selectively determine which transaction data is available for reporting purposes, the consumer 126 can improve the integrity of marketing/offers from subscribing entities directed to the consumer 126. In some embodiments, the transaction data stored in the transaction data database 134 remains unavailable for reporting until the consumer 126 actively selects which transaction data should be available for inclusion in the consumer profile report (i.e., using an opt-in protocol). In some embodiments, the transaction data stored in the transaction data database 134 is available for reporting until the consumer 126 actively selects which transaction data should be not be available for inclusion in the consumer profile report (i.e., using an opt-out protocol). In some embodiments, the consumer 126 can establish various processing rules that opt-in certain types of transactions and opt-out other types of transactions. Such rules can be, for example, based on the merchant at which the transaction was originated. Some rules can be used to protect privacy of the consumer, such as rules regarding medical-based expenditures, or other data that may be subject to the Health Insurance Portability and Accountability Act (HIPAA) regulations. In any event, once the consumer 126 completes the selections, those selections can be received by the profiling computing system 100 and stored (e.g., in the transaction data database 134).

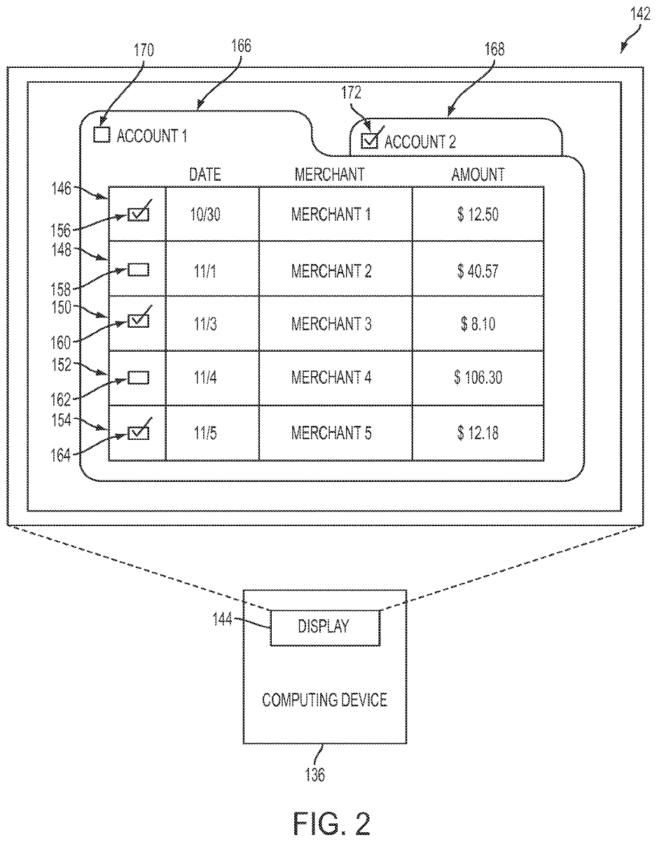

In one embodiment, the consumer 126 can select the transaction data using the computing device 136. FIG. 2 depicts an example simplified graphical user interface 142 that is presented on a display 144 of the computing device 136. This graphical user interface 142 can be presented using hypertext markup language (HTML) and Java scripts, or a dedicated applet or application, or any other suitable interfacing means as would be known or understood in the art. Further, as is to be readily appreciated, the particular layout and design of the graphical user interface 142 can vary without departing from the scope of the present disclosure. Various transaction records 146, 148, 150, 152, 154 can be displayed for one of the consumer's financial accounts (e.g., a demand deposit account or a payment vehicle account) within the graphical user interface 142. Each of the transaction records 146, 148, 150, 152, 154 are shown to display a date, merchant, and transaction amount from the transaction data stored in the transaction data database 134. It will be appreciated, however, that a transaction record can include any additional or alternative transaction data from the transaction data database 134. Each of the transaction records 146, 148, 150, 152, 154 are also shown to have a respective selection fields 156, 158, 160, 162, 164. The selection fields 156, 158, 160, 162, 164 can be individually activated to select the transaction data associated with the transaction records 146, 148, 150, 152, 154 for inclusion in the consumer's consumer profile. The transaction records 146, 148, 150, 152, 154 are also shown to be organized by account and displayed on an account tab 166. Additional account tabs, such as account tab 168, can be provided which, when activated by the consumer 126, display the transaction records associated with the account listed on the account tab. Each of the account tabs 166, 168 can have a respective selection field 170, 172 which can be individually activated to select the transaction data associated with all of the transaction records for that account for inclusion in the consumer's consumer profile. In the example illustrated in FIG. 2, the selection fields 156, 160, 164, and 172 are shown to be activated. As such, the transaction data associated with those transaction records 146, 150, 154 and the activated account tab 168 can be included in a consumer profile report. The transaction data associated with the transaction records 152, 156 will not be included in a consumer profile report.

It will be appreciated that the consumer 126 can tailor the particular transaction data that is available for the consumer profile report in any of a variety of manners. For example, the consumer 126 can restrict/exclude transaction data based upon transaction categories, such as, for example, all transactions associated with certain spend categories, certain merchant identification numbers, or date ranges; certain transaction parameters, such as, for example, transaction amount and merchant identification; and/or the merchants/merchant types that would be receiving the consumer profile report. In some embodiments, merchant categories codes (MCCs) and/or merchant identifiers (MIDs) associated with the transaction data are used by the profiling computing system 100 to group or organize various transactions.

To generate a consumer profile report, the subscribing entity 120 can send a query to the consumer profile computing system 100 that includes various parameters for the consumer profile report. The parameters can control the overall content of the report and can be selected by the subscribing entity 120. In one embodiment, the subscribing entity 120 can select the parameters for the consumer profile report using the computing device 137. In one embodiment, the parameters can comprise a merchant name, a date, a time, geographical location, transaction amount, frequency, distance from merchant, and merchant type. Any suitable parameters, however, can by utilized by the subscribing entity 120 in an attempt to identify, and possible score or rank, particular consumers of interest to the subscribing entity 120.

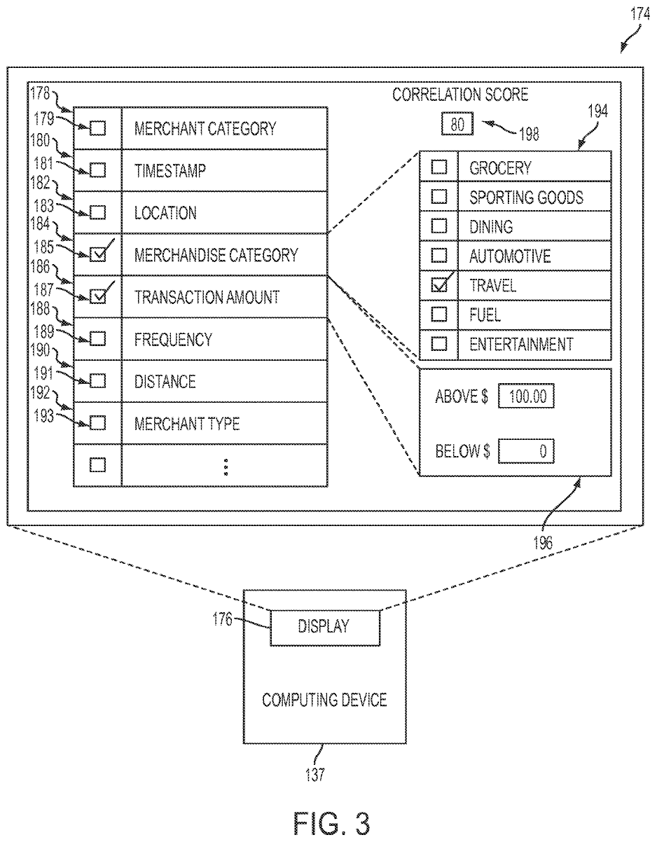

FIG. 3 depicts an example simplified graphical user interface 174 that is presented on a display 176 of the computing device 137. This graphical user interface 174 can be presented using hypertext markup language (HTML) and Java scripts, or a dedicated applet or application, or any other suitable interfacing means as would be known or understood in the art. Various parameters 178, 180, 182, 184, 186, 188, 190, 192 for the consumer profile report can be displayed within the graphical user interface 174. The parameters 178, 180, 182, 184, 186, 188, 190, 192 are shown to comprise MERCHANT CATEGORY, TIMESTAMP, LOCATION, MERCHANDISE CATEGORY, TRANSACTION AMOUNT, FREQUENCY, DISTANCE and MERCHANT TYPE, respectively. Each of the parameters 178, 180, 182, 184, 186, 188, 190, 192 can also have a respective selection field 179, 181, 183, 185, 187, 189, 191, 193. The selection fields selection field 179, 181, 183, 185, 187, 189, 191, 193 can be individually activated to select the associated parameter for inclusion in the consumer profile report. In some embodiments, when one of the selection fields are activated, as illustrated for selection field 185 and 187, respective sub-parameter fields 194, 196 can be provided to obtain additional details regarding the selected parameter. As illustrated in FIG. 3, the sub-parameter field 194 can provide a list of merchant categories for selection by the subscribing entity 120. The sub parameter field 196 can provide a field for entering a transaction amount for selection by the subscribing entity 120.

Once the selected parameters are obtained from the subscribing entity 120 and received by the consumer profiling computing system 100, the consumer profiling engine 118 can generate the consumer profile report. The consumer profile report can be based upon the transaction data from the transaction data database 134 that satisfies the selected parameters from the subscribing entity 120 and which has been selected for inclusion by the consumer 126. In the example illustrated in FIG. 3, the resulting consumer profile report provided to the subscribing entity 120 can include all available transaction data from the transaction data database 134 that relates to transactions for travel that were over one-hundred dollars.

The transaction data associated with the consumer profile report can be certified, verified or otherwise confirmed, in any of a variety of suitable manners to ensure that the consumer 126 is the rightful owner of the transaction data, the transaction data is authentic and that the consumer profile report is reliable. In some embodiments, a certification can be provided to the subscribing entity in any of a number of suitable formats. For example, the consumer profile report can include a consumer profile authentication certificate, or other type of indicia, to convey the consumer profile report is accurate and sound.

The consumer profiling computing system 100 can authenticate and verify the data received from the various sources, such as the demand deposit account provider 122, the issuer financial institution 124, and so forth. In this regard the certification process can allow an indication to be provided to the subscribing entity 120 confirming that the consumer profile report is authentic such that the underlying data traceable back to an authoritative payment source, such as a financial institution or like organization. The certification can also confirm that the transaction data associated with the consumer profile report has not been manipulated, tampered with, or changed. The certification can also confirm that certain transaction data, such as restricted purchases have been removed from the consumer's profile report, which can include, for example, medically related purchases. In some embodiments, the certification associated with the consumer profile report provided to the subscribing entity 120 confirms that the consumer 126 has been given the ability to review and manage their transaction data for inclusion or exclusion from the consumer profile report, while being restricted from altering certain aspects, such as transaction amounts. The certification can also confirm the consumer 126 has been given the ability to opt-out, or been provided with other types of user controls or oversight.

The certification associated with the consumer profile report can also indicate to the subscribing entity 120 that the provider 200 has appropriate mechanisms to manage various aspects of the transaction data, such as dual account ownership, and the ability to incorporate single and joint spend data. Further, example certifications of the consumer profile report can confirm the provider 200 has applied sufficient governance, controls and monitoring to ensure authenticity of the data and, in some cases, has formal procedures for managing discrepancies and disputes. In some embodiments, the certification confirms the provider 200 has independent reviews of its controls and procedure and such reports can be made available to the subscribing entity 120.

As is to be appreciated, other aspects of the transaction data, the consumer profile report, and the consumer profiling computing system 100 can be authenticated and certified, as may be desirable for various implementations. An indication of the certification can be transmitted to the subscribing entity 120 using any number of techniques. For example, the consumer profile report, when viewed on the computing device 137, can include a graphical element indicating to the subscribing entity 120 that the consumer profile report has been certified by the provider 200.

In one embodiment, a correlation score can be assigned to each consumer in the transaction data database 134 and can be based upon the selected parameters from the subscribing entity 120 and the consumer's transaction data stored in the transaction data database 134. The correlation score can be based upon a range (e.g., 0-125) and can indicate the extent to which a consumer's transaction data matches the selected parameters from the subscribing entity 120. The correlation score can be determined by comparing the selected parameters by the merchant to the consumer's transaction data. The more transaction data that the consumer has that matches the selected parameters, the higher the correlation score associated with that consumer.

As illustrated in FIG. 3, a correlation score 198 can be assigned by consumer profiling computing system 100 based on the subscribing entity's parameter selections. In this instance, the results of the report can include a list of the consumers that have a correlation score higher than the desired correlation score from the subscribing entity 120. The subscribing entity 120 can then provide an offering, such as a targeted marketing campaign (e.g., mailed coupon) to each of the consumers from the consumer profile report. It will be appreciated that the subscribing entity 120 can select a correlation score that is suitable to achieve a particular object, such as reach a certain number of consumers within a geographic target. In some embodiments, the correlation scoring can be dynamic, such that the subscribing entity 120 can set the certain scoring parameters such as the scoring range, for example. In these embodiments, the subscribing entity 120 can also provide weighted scoring for certain of the selected parameters to vary how much affect each parameter has on the overall correlation score of the consumers.

It is to be appreciated that any of a variety of suitable parameters can be available for the consumer profile report and can, in some cases, be determined by the type of transaction data and/or transaction parameters stored in the transaction data database 134. In one embodiment, a provider 200, sometimes referred to as a consumer report provider, can be associated with the consumer profiling computing system 100, as illustrated in FIG. 1. The provider 200 can control the particular parameters that are available for selection by the subscribing entity 120 via the graphical user interface 174. In some embodiments, the provider 200 can allow the subscribing entity to control the particular parameters that are available for selection by the subscribing entity 120. It will be appreciated that information for the selected parameters can be entered by a subscribing entity 120 into a graphical user interface 174 in any of a variety of suitable manners, such as via a text fillable field, for example. In some embodiments, the provider 200 can initiate techniques to certify the transaction data received from the various participating members.

In some embodiments, the provider 200 can manage the attributes of the transaction data such as by assigning metadata attributes to transactions and/or providing advanced classification of merchants into unique constructs. For example, if a new merchant is not categorized in the consumer profiling computing system, a consumer can suggest a category to the provider 200. The provider 200 can then categorize the merchant based upon the consumer's suggestion and/or the merchant's Merchant Category Code (MCC). The provider 200 can additionally or alternatively analyze the merchant's name and recommend a proprietary merchant categorization and/or assign certain attributes to the merchant.

It will be appreciated that the consumer profiling computing system 100 can be configured to permit profile associations based upon the transaction data stored in the transaction data database 134. For example, consumers within a household can be permitted to link their transactions together within the transaction data database 134 such that the household could be provided with a household correlation score. In another example, consumers within a group can be permitted to link their transactions together within the transaction data database 134 such that the group could be provided with a group correlation score.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

1. A computer-implemented method for providing a transaction selection interface for a consumer, the method comprising:
displaying, by one or more processors on a first account tab of the transaction selection interface for a first account of the consumer, at least one of a merchant name, a date, a time, a geographical location, a transaction amount, a frequency of transactions, a distance from a merchant, and a merchant type from first transaction data, as displayed first transaction data, wherein the first transaction data includes a first purchase transaction by the consumer from one or more merchants, wherein the first account tab further includes a first account tab selection field that is configured to be activated to select transaction data associated with all transaction records for the first account of the consumer, wherein the first account tab selection field is a first selectable checkbox in the first account tab;
displaying, by the one or more processors on the first account tab of the transaction selection interface, at least one of a merchant name, a date, a time, a geographical location, a transaction amount, a frequency of transactions, a distance from a merchant, and a merchant type from second transaction data, as displayed second transaction data, wherein the second transaction data includes a second purchase transaction by the consumer from the one or more merchants, wherein the transaction selection interface further includes a second account tab that includes a second account tab selection field that is configured to be activated to select transaction data associated with all transaction records for a second account of the consumer, wherein the second account tab selection field is viewable while the first account tab selection field of the first account tab and the displayed first transaction data of the first account tab are displayed, and wherein the second account tab selection field is a second selectable checkbox in the second account tab;
activating, by the one or more processors, a selection field of the displayed first transaction data based on an action by the consumer to individually activate the selection field for the displayed first transaction data, and not activating a selection field of the displayed second transaction data; and
generating, by the one or more processors, a consumer profile report for the consumer based on the selected transaction data, wherein the selected transaction data includes an indication that the displayed first transaction data was selected by the consumer individually activating the selection field for the displayed first transaction data, and wherein the selected transaction data includes an indication that the displayed second transaction data was not selected by the consumer individually not activating the selection field for the displayed second transaction data,
wherein the consumer profile report includes the selected first transaction data and excludes the second transaction data.

2. The computer-implemented method of claim 1, further comprising:
certifying, by the one or more processors, an authenticity of the consumer profile report as a consumer profile authentication certificate.

3. The computer-implemented method of claim 2, further comprising:
transmitting, by the one or more processors, the consumer profile authentication certificate.

4. The computer-implemented method of claim 1, wherein the first purchase transaction is linked to a payment vehicle.

5. (canceled)

6. The computer-implemented method of claim 1, further comprising:
displaying, by the one or more processors, the generated consumer profile report.

7. The computer-implemented method of claim 1, wherein the first transaction data and the second transaction data is available for the consumer profile report using an opt-in protocol.

8. The computer-implemented method of claim 1,
wherein the first transaction data and the second transaction data is available for the consumer profile report using an opt-out protocol.

9. The computer-implemented method of claim 1,
wherein the first transaction data is selected and the second transaction data is not selected, based on one or more processing rules that opt-in certain types of transactions and opt-out other types of transactions.

10. A non-transitory computer readable medium having instructions for providing a transaction selection interface for a consumer, the instructions stored thereon and which, when executed by one or more processors, cause the one or more processors to:
display, on a first account tab of the transaction selection interface for a first account of the consumer, at least one of a merchant name, a date, a time, a geographical location, a transaction amount, a frequency of transactions, a distance from a merchant, and a merchant type from first transaction data, as displayed first transaction data, wherein the first transaction data includes a first purchase transaction by the consumer from one or more merchants, wherein the first account tab further includes a first account tab selection field that is configured to be activated to select transaction data associated with all transaction records for the first account of the consumer, wherein the first account tab selection field is a first selectable checkbox in the first account tab;
displaying, on the first account tab of the transaction selection interface, at least one of a merchant name, a date, a time, a geographical location, a transaction amount, a frequency of transactions, a distance from a merchant, and a merchant type from second transaction data, as displayed second transaction data, wherein the second transaction data includes a second purchase transaction by the consumer from the one or more merchants, wherein the transaction selection interface further includes a second account tab that includes a second account tab selection field that is configured to be activated to select transaction data associated with all transaction records for a second account of the consumer, wherein the second account tab selection field is viewable while the first account tab selection field of the first account tab and the displayed first transaction data of the first account tab are displayed, and wherein the second account tab selection field is a second selectable checkbox in the second account tab;
activate a selection field of the displayed first transaction data based on an action by the consumer to individually activate the selection field for the displayed first transaction data, and not activating a selection field of the displayed second transaction data; and
generate a consumer profile report for the consumer based on the selected transaction data, wherein the selected transaction data includes an indication that the displayed first transaction data was selected by the consumer individually activating the selection field for the displayed first transaction data, and wherein the selected transaction data includes an indication that the displayed second transaction data was not selected by the consumer individually not activating the selection field for the displayed second transaction data,
wherein the consumer profile report includes the selected first transaction data and excludes the second transaction data.

11. The non-transitory computer medium of claim 10, wherein the first purchase transaction is linked to a payment vehicle.

12. (canceled)

13. The non-transitory computer medium of claim 10, wherein the first transaction data is selected and the second transaction data is not selected, based on one or more processing rules that opt-in certain types of transactions and opt-out other types of transactions.

14. The non-transitory computer medium of claim 10, wherein the instructions further cause the processor to:
display the generated consumer profile report.

15. The non-transitory computer medium of claim 10, wherein the first transaction data and the second transaction data is available for the consumer profile report using an opt-in protocol.

16. The non-transitory computer medium of claim 10, wherein the first transaction data and the second transaction data is available for the consumer profile report using an opt-out protocol.

17. A system for providing a transaction selection interface for a consumer, the system comprising at least one memory storing instructions and at least one computer processor, wherein the at least one computer processor is configured to execute the instructions for:
displaying, on a first account tab of the transaction selection interface for a first account of the consumer, at least one of a merchant name, a date, a time, a geographical location, a transaction amount, a frequency of transactions, a distance from a merchant, and a merchant type from first transaction data, as displayed first transaction data, wherein the first transaction data includes a first purchase transaction by the consumer from one or more merchants, wherein the first account tab further includes a first account tab selection field that is configured to be activated to select transaction data associated with all transaction records for the first account of the consumer, wherein the first account tab selection field is a first selectable checkbox in the first account tab;
displaying, on the first account tab of the transaction selection interface, at least one of a merchant name, a date, a time, a geographical location, a transaction amount, a frequency of transactions, a distance from a merchant, and a merchant type from second transaction data, as displayed second transaction data, wherein the second transaction data includes a second purchase transaction by the consumer from the one or more merchants, wherein the transaction selection interface further includes a second account tab that includes a second account tab selection field that is configured to be activated to select transaction data associated with all transaction records for a second account of the consumer, wherein the second account tab selection field is viewable while the first account tab selection field of the first account tab and the displayed first transaction data of the first account tab are displayed, and wherein the second account tab selection field is a second selectable checkbox in the second account tab;
activating a selection field of the displayed first transaction data based on an action by the consumer to individually activate the selection field for the displayed first transaction data, and not activating a selection field of the displayed second transaction data; and
generating a consumer profile report for the consumer based on the selected transaction data, wherein the selected transaction data includes an indication that the displayed first transaction data was selected by the consumer individually activating the selection field for the displayed first transaction data, and wherein the selected transaction data includes an indication that the displayed second transaction data was not selected by the consumer individually not activating the selection field for the displayed second transaction data,
wherein the consumer profile report includes the selected first transaction data and excludes the second transaction data.

18. The system of claim 17, wherein the at least one computer processor is further configured to execute instructions for:
displaying the generated consumer profile report.

19. (canceled)

20. The system of claim 17, wherein the at least one computer processor is further configured to execute instructions for:
certifying an authenticity of the consumer profile report as a consumer profile authentication certificate.
